(19) United States
(12) Patent Application Publication
(10) Pub. No.: US 2026/0072935 A1
(43) Pub. Date: Mar. 12, 2026

(54) ASYNCHRONOUS PROCESSING SYSTEM FOR UNSTRUCTURED DATA

(71) Applicant: Optum, Inc., Minnetonka, MN (US)

(72) Inventors: Prashant Kumar SINHA, Uttar Pradesh (IN); Babu Shashidhar Peter PALATHOTI, South Jordan, UT (US)

(21) Appl. No.: 19/061,418

(22) Filed: Feb. 24, 2025

Related U.S. Application Data
(60) Provisional application No. 63/691,780, filed on Sep. 6, 2024.

(51) Int. Cl. G06F 16/25

(52) U.S. Cl. CPC G06F 16/258

(57) ABSTRACT

Various embodiments of the present disclosure provide an automated asynchronous decisioning process that improves the functionality of a computer in various aspects. The process may comprise receiving, an input data object that comprising a set of unstructured data elements and converting the input data object to a structured data object by (i) extracting, using an optical character recognition model, a set of input features from the input data object, (ii) generating, using a structuring ruleset, a structured data element based on the set of input features, and (iii) storing the structured data element within a polling queue and in association with the request identifier. The process may comprise receiving, from a polling component, a polling request and responsive to receiving the polling request, providing, to the polling component, at least one of the request identifier, the structured data element, or a conversion status for the structured data object.

### BACKGROUND

In many domains, computers are leveraged to process large volumes of unstructured data, such as images, portable document format (PDF) documents, and/or the like. Traditionally, processing such files requires a sequential two-step process comprising (1) extracting information and subsequently (2) applying a ruleset to the extracted information. Automating such processes face several technical challenges, including timeouts, delays, redundant processing operations, and a lack of flexibility caused by tightly coupling data conversion tools with subsequent decisioning software.

In some cases, delays in the decisioning responses may be addressed by limiting the processing task to unstructured data of particular data formats. However, such techniques limit the flexibility of the system and may still lead to delays due to other exception scenarios, such as incorrect data upload, ambiguities in extracted information, and/or the like. Moreover, due to the sequential nature of traditional automated decisioning systems, during delays at a first data extraction component, a second decisioning component may sit idle. This causes a stop and go processing architecture that is inefficient and fails to consistently achieve real-time decisioning responses.

### BRIEF DESCRIPTION OF THE DRAWINGS

FIG. 1 depicts a block diagram of an example architecture in accordance with some embodiments of the present disclosure.

FIG. 2 depicts a block diagram of an example predictive data analysis computing entity in accordance with some embodiments of the present disclosure.

FIG. 3 depicts a block diagram of an example client computing entity in accordance with some embodiments of the present disclosure.

FIG. 4 depicts a dataflow diagram of an asynchronous automated decisioning system in accordance with some embodiments of the present disclosure.

FIG. 5 depicts a sequence diagram of an asynchronous automated decisioning approach in accordance with some embodiments of the present disclosure.

FIG. 6 depicts an operational example of a data conversion approach in accordance with some embodiments of the present disclosure.

FIG. 7 depicts a flowchart diagram of an asynchronous conversion process in accordance with some embodiments of the present disclosure.

FIG. 8 depicts a flowchart diagram of an asynchronous decisioning process in accordance with some embodiments of the present disclosure.

### DETAILED DESCRIPTION

Various embodiments of the present disclosure provide an automated adjudication architecture for a computing system that improves the functionality of a computer with respect to processing unstructured data. To do so, the automated adjudication architecture defines complementary components that are individually configured to break sequential autonomous decisioning systems into multiple, asynchronous processes. The complementary components, for example, may comprise a first conversion component that is configured to process an unstructured input data object to incrementally extract individually processable data segments (e.g., structured data) from the otherwise unstructured input data object. In some examples, although the input data object may be unstructured, it may comprise structured data. The conversion component may be complemented by a second, decisioning component that is configured to asynchronously process the individually processable units of information extracted by the conversion component. To overcome performance deficiencies with traditional processing techniques, the automated adjudication architecture implements additional interface components that link the conversion component to the decisioning component without inhibiting the flexibility of either individual component. The interface component, for example, may comprise a submission component that is configured to instantiate a request and provide an input data object to the conversion component for processing. In addition, or alternatively, the interface services may comprise a polling component that is configured to transfer data from the conversion component to the decisioning component at a polling interval. In other examples, the decisioning component and the decisioning component may interact directly (e.g., without a poling component) to transfer data. In this manner, the automated adjudication architecture enables the continuous, asynchronous execution of the conversion component and decisioning component that avoids time delays, backlogs, and other processing constraints that traditionally limit automated decisioning system.

In some embodiments of the present disclosure, the automated adjudication architecture defines a set of modular software containers to separate the operation of various components. For instance, one or more instantiations of the conversion component may operate within a first computing environment (e.g., software container, virtual machine). In addition, or alternatively, one or more instantiations of the decisioning component may operate within a second computing environment. By doing so, the automated adjudication architecture enables modifications to one component without impacting other components defined within the system. In some examples, such modifications may be implemented by modifying the operations of the interface components that link the conversion and decisioning components. For example, instead of taking one or both of the components offline, the automated adjudication architecture may enable dynamic delinking operations by delaying polling requests from a polling component. In this manner, the automated adjudication architecture improves upon the flexibility of traditional decisioning systems by enabling modularized testing, modification, and/or other maintenance operations to individual components without impacting the overall performance of the system.

In some embodiments of the present disclosure, the components of the automated adjudication architecture perform a set of asynchronous processing operations that improve the speed and efficiency of decisioning systems through a divide and conquer approach. For example, the conversion component may incrementally extract and queue portions of structured data elements from an input data object. In this manner, the conversion component may preemptively structure unstructured data for a subsequent decisioning component in an element-level data structure that reduces the complexity of a decisioning task. By doing so, the automated adjudication architecture may improve the performance of downstream decisioning components that enable improved processing that, unlike traditional techniques, may handle unstructured data objects of any format without reductions in decisioning accuracy. Moreover, by breaking a decisioning process into element-level decisions, the automated adjudication architecture reduces the complexity of decisioning tasks, which enable real-time decision responses. Ultimately, these element level responses may be aggregated for a request to output a request response faster than traditional decisioning systems.

Examples of technologically advantageous embodiments of the present disclosure comprise an improved arrangement of various computer components for processing data, among other aspects of the present disclosure, that improve the functioning of a computer. The improved arrangement of computer components, for example, may comprise a specific arrangement of a conversion component, polling component, and decisioning component that may separate a decisioning task into a set of parallel operations. By doing so, the improved arrangement of computer components may enable the continuous, asynchronous execution of the data conversion and decisioning tasks that avoid time delays, backlogs, and other processing constraints that traditionally limit the data processing capabilities of computers with respect to both time and processing requirements. Other technical improvements and advantages may be realized by one of ordinary skill in the art.

### I. OVERVIEW OF EMBODIMENTS

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

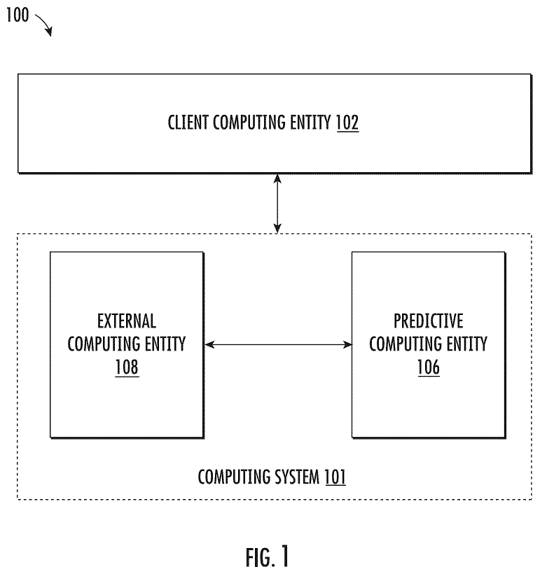

FIG. 1 depicts a block diagram of an example architecture 100 in accordance with some embodiments of the present disclosure. The architecture 100 comprises a computing system 101 configured to receive a request, such as a processing request, and/or the like, from client computing entities 102, process the request, and provide a request response to the client computing entities 102. The example architecture 100 may be used in a plurality of domains and not limited to any specific application as disclosed herewith. The plurality of domains may comprise healthcare, industrial, manufacturing, computer security, and/or the like to name a few.

In accordance with various embodiments of the present disclosure, one or more machine learned models may be trained to generate candidate outputs, candidate output scores, and/or other machine learned outputs. The models may be adapted to a data conversion mechanism and/or asynchronous decisioning mechanism that may process an input data object, and/or structure data elements derived therefrom, through an automated adjudication architecture. Some techniques of the present disclosure may adapt traditional models to a cohesive framework, such as the automate adjudication architecture, for more efficiently (e.g., in terms of speed) handling processing requests.

In some embodiments, the computing system 101 may communicate with at least one of the client computing entities 102 using one or more communication networks. Examples of communication networks comprise any wired or wireless communication network comprising, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a predictive computing entity 106 and one or more external computing entities 108. The predictive computing entity 106 and/or one or more external computing entities 108 may be individually and/or collectively configured to receive requests from client computing entities 102, process the requests to generate a code predictions, and provide the code predictions to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, each storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., conversion techniques, decisioning techniques, processing techniques) described herein. The external computing entities 108, for example, may comprise and/or be associated with one or more entities that may be configured to receive, transmit, store, manage, and/or facilitate datasets, and/or the like. The external computing entities 108, for example, may comprise data sources that may provide such datasets, and/or the like to the predictive computing entity 106 which may leverage the datasets, such as structured data objects, polling queues, and/or the like, to perform one or more steps/operations of the present disclosure, as described herein. In some examples, the datasets may comprise an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for an information domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data) from the use of the machine learning model may be received and/or stored by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Computing Entity

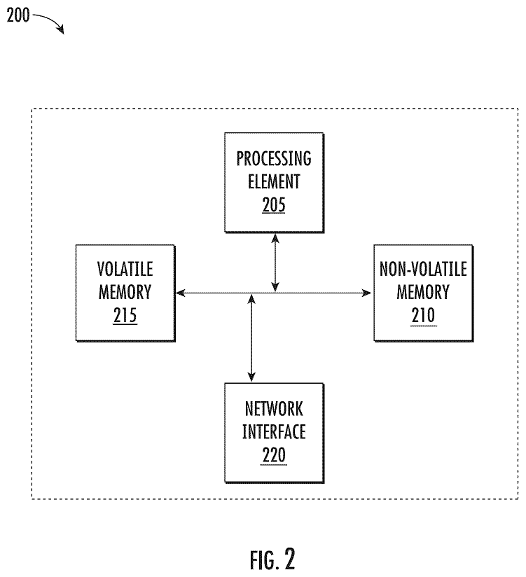

FIG. 2 depicts a block diagram of an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably) and/or volatile memory 215 (also referred to as volatile media, storage, memory storage, memory circuitry, and/or similar terms used herein interchangeably), as discussed above.

In some embodiments, non-volatile memory 210 may comprise a computer-readable storage medium may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium comprising random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (comprising various levels), flash memory, register memory, and/or the like. It will be appreciated that where embodiments are described to use a computer-readable storage medium, other types of computer-readable storage media may be substituted for or used in addition to the computer-readable storage media described above.

As will be recognized, the non-volatile memory 210 and/or the volatile memory 215 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, comprising as computer program products that comprise articles of manufacture. Such computer program products may comprise one or more software components comprising, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (comprising volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile 210 of the computing entity 200. In addition, or alternatively, at least a second portion of the computer program product may be stored within the volatile and/or non-volatile memory of a client computing entity.

As indicated, in some embodiments, the computing entity 200 may also comprise one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable component interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio component (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may additionally or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively comprise, or be in communication with, one or more output elements/devices (not shown), such as one or more speakers, visual display devices, haptic feedback devices, motion devices (e.g., electromechanically actuated devices), and/or the like.

### B. Example Client Computing Entity

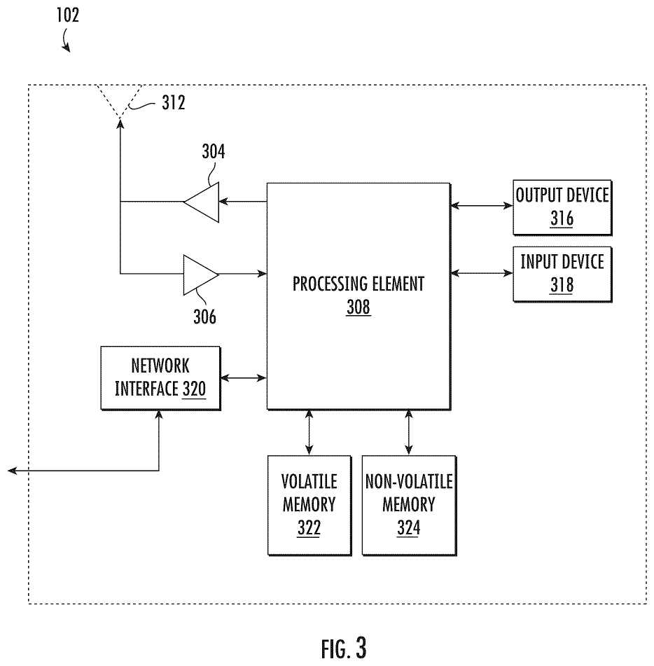

FIG. 3 depicts a block diagram of an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., comprising executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, comprising Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, comprising cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies comprising RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may additionally or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. EXAMPLE SYSTEM OPERATIONS

As indicated, various embodiments of the present disclosure make important technical contributions to the functionality of computer, such as automated decision system. In particular, systems and methods are disclosed herein that implement an asynchronous automated decision architecture that provides a new distribution of computer functionality for a decisioning task. By doing so, the asynchronous automated decision architecture enables an asynchronous divide and conquer approach for decisioning systems that improves the speed, reliability, and efficiency of an automated decisioning task. Thus, in turn, may improve the functionality of a computer with respect to various computing tasks, such as data conversion, network communication, memory allocation, and the like.

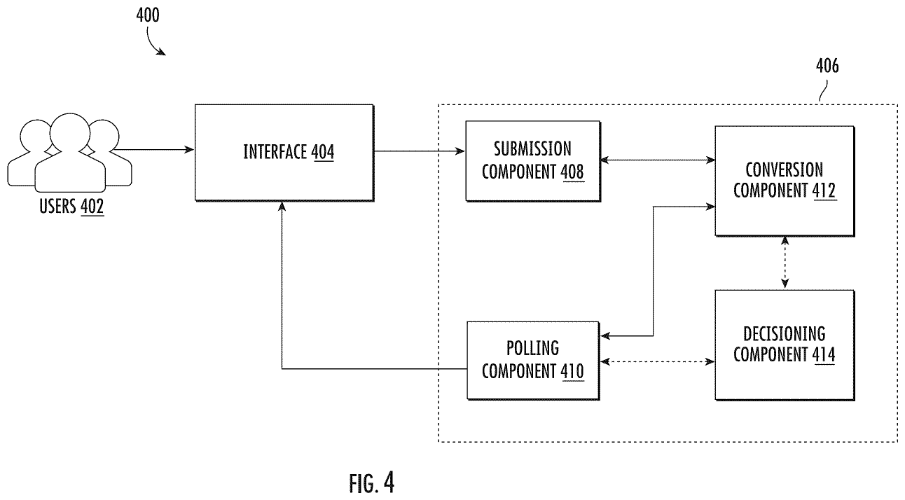

FIG. 4 depicts a dataflow diagram 400 of an asynchronous automated decisioning system in accordance with some embodiments of the present disclosure. The asynchronous automated decisioning system, for example, may comprise an automated adjudication architecture 406 that comprises a set of components configured to operate, asynchronously, to process an input data object. The automated adjudication architecture 406, for example, may comprise a conversion component 412 and decisioning component 414 that may be executed asynchronously to individually process an input data object. The decisioning component 414 and/or conversion component 412 may be connected by one or more interface components, such as the submission component 408 and/or the polling component 410, to enable continuous operations without interruption, delays, and/or the like. By doing so, the automated adjudication architecture 406 enables near-real time interactions with users 402 via any interface 404.

In some embodiments, the automated adjudication architecture 406 is an end-to-end processing architecture that defines a set of components configured to asynchronously processing unstructured data to generate an output response. The automated adjudication architecture 406, for example, may comprise a set of interconnected components that individually operate to collaboratively apply decisioning rulesets to unstructured data. The automated adjudication architecture 406 leverages various technical components to apply a divide and conquer approach that enables efficient, scalable, and reliable processing of unstructured data. For example, in a first component, the conversion component 412, the automated adjudication architecture 406 executes data conversion techniques, such as optical character recognition (OCR), structuring rulesets, and/or the like, to extracting structured data elements from an unstructured input data object. In addition, or alternatively, in a second component, the decisioning component 414, the automated adjudication architecture 406 asynchronously executes decisioning rulesets to convert a structured data element to an element decision. In some examples, the automated adjudication architecture 406 may define a distributed system, with instantiations of different components executed in separate software containers to allow for independent scaling, updates, and maintenance without impacting the overall performance of an asynchronous automated decisioning system.

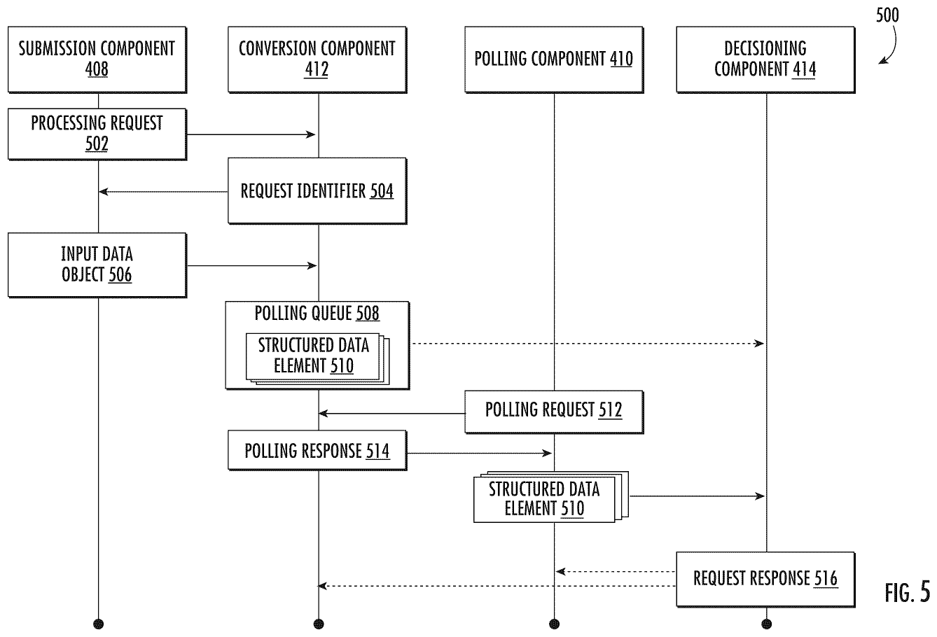

As described in further detail with reference to FIG. 5, the automated adjudication architecture 406 may receive an input data object (e.g., an image, scanned document) through a submission component 408. The submission component 408 may instantiate a request and pass the input data object to the conversion component 412. The conversion component 412 may process (e.g., via one or more OCR and/or machine learning models) the input data object to generate a structured data elements of a structured data object that complies with one or more predefined schemas recognized by a downstream decisioning component 414. In response to a polling request, the conversion component 412 provides structured data elements to a polling component 410, which forwards the structured data elements to the decisioning component 414. The decisioning component 414 applies configurable rulesets to the forwarded structured data elements to generate a request response for the processing request, which may be returned to the users 402 via the interface 404. The modular nature of the automated adjudication architecture 406 allows for flexibility in deployment and maintenance. Individual components, for example, may be updated and/or replaced without impacting the entire system. By way of example, an OCR module of the conversion component 412 may modified or replaced, new decision rulesets may be deployed, and/or the like without requiring changes to other parts of the architecture. This modularity also enables the system to be adapted for different types of input data objects and/or decisioning processes to further enhance the speed and efficiency of the decisioning task.

In some embodiments, the automated adjudication architecture 406 receives an input data object from a user 402 via an interface 404 with the automated adjudication architecture 406. The interface 404, for example, may comprise a mobile application, a web portal, plug-in and/or the like that enables communication (e.g., via API calls) between the users 402 and the automated adjudication architecture 406. The interface 404, for example, may comprise mobile application that comprises an upload icon for uploading an input data object to the automated adjudication architecture 406. In addition, or alternatively, the interface 404 may comprise a scanning interface configured to scan physical documents for upload to the automated adjudication architecture 406. In this manner, a user 402 may interact with the interface 404 to initiate a processing request and upload an input data object for processing with the processing request.

In some embodiments, the automated adjudication architecture 406 comprises a submission component 408 that is configured to receive a processing request and/or input data objects from the interface 404. The submission component 408, for example, may comprise an entry point for providing a processing request, request metadata, and/or input data objects to the automated adjudication architecture 406. For instance, the submission component 408 may comprise an API endpoint, and/or any other interface, configured to receive requests (e.g., HTTP requests) from an interface 404 that comprise request metadata and/or associated input data objects. In some examples, the submission component 408 may leverages web component technologies, such as REST APIs, and/or the like, to provide a standardized interface for instantiating a processing request. In response to a processing request, the submission component 408 may perform initial validation and/or preprocessing of the incoming data. This may comprise checking for required fields, sanitizing inputs, and/or assigning a unique identifier to the processing request. In addition, or alternatively, the submission component 408 may initiate an asynchronous automated decisioning process by passing received data to downstream components of the automated adjudication architecture 406, such as the conversion component 412.

In some examples, the submission component 408 provides a decoupling layer between external systems, such as the interface 404, providing processing requests and the internal components of the automated adjudication architecture 406. This allows the internal implementation details of the automated adjudication architecture 406 to be abstracted away from users 402. Moreover, the submission component 408 may control the flow of information to the automated adjudication architecture 406 by implementing one or more rate limiting, authentication, and/or logging to ensure secure and controlled access to the automated adjudication architecture 406.

In some embodiments, the conversion component 412 is a component of the automated adjudication architecture 406 that is configured to convert input data objects to structured data objects tailored for processing by downstream components of the automated adjudication architecture 406. The conversion component 412 may comprise one or more data conversion tools that may be applied to implement a structuring ruleset configured to extract individually processable units of structured information from an input data object. For instance, the conversion component 412 may comprise an OCR module that asynchronously processes input data objects to extract unstructured data elements and transform them into one or more structured data elements. These structured data elements may be then stored for retrieval by a polling component 410.

The conversion component 412 leverages one or more data conversion tools to implement a structuring ruleset. The modular nature of the automated adjudication architecture 406 enables modifications to the structuring ruleset and/or data conversion tools based on a use case, input data object format, and/or any other design criteria. In some examples, the data conversion tools may comprise an OCR model, one or more classification models, and/or the like. The OCR model, for example, may be configured to extract a set of input features from an input data object. In addition, or alternatively, the one or more classification models may be configured to classify up to each of the extracted set of features as a feature of interest. A feature of interest, for example, may comprise a time feature, an element feature, a value feature, and/or the like. In some examples, the conversion component 412 may combine one or more subsets of the set of features into individually processable structured data elements in accordance with a structuring ruleset that defines aspects of data that may be used by the downstream decisioning component 414 to generate an element decision.

In some embodiments, the conversion component 412 comprises a containerized component (e.g., software implemented within a software container, software environment, server, virtual machine) that comprises and/or has access to a set of data conversion tools, memory data structures, and/or processing resources. The memory data structures, for example, may comprise a polling queue configured for temporary storage of structured data elements generated by conversion component 412. In addition, or alternatively, the memory data structures may comprise one or more long term memory resources (e.g., persistent datastore) configured for long term storage of structuring rulesets and/or inputs or output to a conversion process (e.g., structured data elements, structured data objects, and/or input data objects) and/or one or more short term memory resources (e.g., caches) configured for short term storage of the inputs or output to the conversion process (e.g., structured data elements, structured data objects, and/or input data objects). In some examples, the individualized computing resources of the conversion component 412 allows the conversion component 412 to operate asynchronously from other components in the system, improving overall system performance and/or scalability.

In some embodiments, the conversion component 412 comprises bridge between unstructured inputs and structured data that may be processed by a downstream decisioning component 414 for automated decisioning. By front-loading the complex task of data extraction and structuring in an asynchronous process, the conversion component 412 enables more efficient processing in later stages of the automated adjudication architecture 406. Moreover, the conversion component 412 may by independently scaled (e.g., through parallel instantiations within one or more software containers) and/or updated to handle new data formats and/or improve extraction accuracy over time.

In some embodiments, the conversion component 412 is connected to a decisioning component 414 by an asynchronous polling component 410 that facilitates asynchronous communications between the different stages of automated adjudication architecture 406. The polling component 410, for example, may comprise an intermediate interface within an automated adjudication architecture 406 that asynchronously transfers data between the conversion component 412 and the decisioning component 414. For example, the polling component 410 may initiate polling requests at defined intervals to enable asynchronous processing of requests between the conversion component 412 and decisioning component 414. A polling request, for example, may retrieve queued information (e.g., stored within the polling queue of the conversion component 412) from the conversion component 412 and forward the information to the decisioning component 414.

In some examples, the polling component 410 may comprise software component (e.g., another containerized component) that comprises and/or has access to one or more memory data structures, processing resources, and/or polling mechanisms. For instance, the polling component 410 may leverage a polling mechanism to execute a polling request at a defined frequency. The polling mechanism, for example, may comprise a time component (e.g., clock) and periodic trigger (e.g., set of clock cycles) that triggers an execution of a polling request at a defined frequency to check for newly processed data from the conversion component 412. By doing so, the polling component 410 may enable efficient communication between components without requiring constant active connections.

The polling mechanism of the polling component 410 may comprise any polling structures, such as a RESTful API call, message queue, and/or any other communication protocol configured to facilitate an interaction between the polling component 410 and the decisioning component 414. In some examples, the periodic trigger may be executed on a polling interval (e.g., 30 seconds, 1 minute, 5 minutes, 1 hour, 1 day) that may be configurable based on historical conversion times, and/or the like. In addition, or alternatively, the polling interval may be dynamically set based on a number of processing requests, data types of submitted input data objects, and/or the like. In this respect, the polling component 410 may receive state data from the submission component 408 to dynamically toggle a polling interval between one or more interval options based on a status (e.g., number of processing requests received) of the conversion component 412.

Using the polling mechanism, the polling component 410 may provide polling requests to the conversion component 412 at regular intervals to retrieves structured data elements that are ready for processing, along with their associated request identifiers, conversion statuses, and/or request metadata. The polling component 410 may forwards this information to the decisioning component 414 for further processing. In this way, the polling component 410 enables asynchronous and modular processing within the automated adjudication architecture 406, which allows for a decoupling of the conversion and decisioning processes of the automated adjudication architecture 406. This, in turn, allows for independent scaling and maintenance of these components and facilitates easier updates to individual components without impacting the entire system.

In some embodiments, the decisioning component 414 comprises a containerized component (e.g., software implemented within a software container, software environment, server, virtual machine) that comprises and/or has access to a set of decisioning tools, memory data structures, and/or processing resources. The memory data structures, for example, may comprise one or more long term memory resources (e.g., persistent datastore) configured for long term storage of decisioning rulesets and/or one or more inputs or outputs to a decisioning task (e.g., structured data elements, structured data objects, element decisions, request metadata, request responses) and/or one or more short term memory resources (e.g., caches) configured for short term storage of the one or more inputs or outputs to a decisioning task (e.g., structured data elements, structured data objects, element decisions, request metadata, request responses). In some examples, the individualized computing resources of the decisioning component 414 allows the conversion component 412 to operate asynchronously from other components in the system, improving overall system performance and/or scalability.

In some examples, the decisioning component 414 may comprise and/or have access to one or more decisioning rulesets that may be applied to structured data objects and/or structured data elements thereof to generate one or more decisions for a processing request. By way of example, the decisioning rulesets may be implemented by one or more decision tree algorithms, rule engines, and/or other decision-making frameworks to evaluate structured data elements against a set of defined rules. In some examples, the decisioning component 414 may execute the decisioning rulesets to generate an element decision (e.g., approval or rejection) for up to each of a set of structured data elements of a structured data object. In some examples, the decisioning component 414 may execute the decisioning rulesets for up to each structured data element in an order that it is received from the polling component 410 to incrementally generate element decisions for a set of structured data objects.

By way of example, the decisioning component 414 may receive structured data elements from the polling component 410 as a polling interval. The decisioning component 414 may applies one or more decisioning rulesets to up to each of the received structured data elements, in some examples using the structured data element and request metadata corresponding thereto, to generate an element decision. The element decisions may stored (e.g., within the containerized environment) in association with request identifier corresponding to a structured data object for a processing request. In response to a conversion status that identifies a completed conversion of an input data object to the structured data object, the decisioning component 414 may aggregate a set of element decisions corresponding to the structured data elements of the structured data object, generate a request response based on the aggregated set of element decisions, and store the request response for the polling component 410. The polling component 410 may receive the request response and provide the request response to the interface 404 in response to the processing request.

In this way, the decisioning component 414 may asynchronously process portions of a structured data object to automate an adjudication process. By applying rulesets to structured data elements, the decisioning component 414 may enables faster and more accurate decision-making compared to traditional sequential approaches. Moreover, the modular nature of the decisioning component 414 may enable updates to decisioning rulesets on a periodic basis to enable up-to-date decisions without impacting the overall performance of the system.

In some embodiments, the conversion component 412 is implemented within a first software container. In addition, or alternatively, the decisioning component 414 is implemented within a second software container that is different than the first software container. By doing so, the decisioning component 414, and/or one or more decisioning rulesets thereof, may be updated without impacting the operations of the conversion component 412. By way of example, the decisioning component 414 may receive an update to a decisioning ruleset. Responsive to the update to the decisioning ruleset, the decisioning component 414 may disable the second software container without impacting the first software container, modify the second software container, and enable the second software container after the modification. In some examples, the decisioning component 414 may disable the second software container without impacting the first software container by delaying the polling request from the polling component 410.

In some embodiments, a software container comprises a unit of software that may individually and asynchronously execute a component within an automated adjudication architecture 406. Software containers, for example, may provide a standardized, isolated environment for running applications and/or their dependencies. In some examples, the software containers may comprise system-level virtualizations that create lightweight, portable, and/or self-sufficient units that may run consistently across different computing environments. Containers, for example, may encapsulate an component of the automated adjudication architecture 406 along with its runtime, system tools, libraries, settings, and/or the like. This allows the components of the automated adjudication architecture 406 to be executed, modified, debugged, and/or in isolation to enable fine-grained control over resource allocation, such as CPU, memory, and I/O, for each portion of a decisioning process. In this manner, the automated adjudication architecture 406 enables an asynchronous automated decisioning approach for handling input data objects of any data type without reducing the flexibility, speed, and/or efficiency of a decisioning process. An example asynchronous automated decisioning approach will be described in further detail with reference to FIG. 5.

FIG. 5 depicts a sequence diagram 500 of an asynchronous automated decisioning approach in accordance with some embodiments of the present disclosure. As depicted by the sequence diagram 500, the asynchronous automated decisioning approach may comprise a set of asynchronous operations performed by various components (e.g., interfaces, containerized services) of the automated adjudication architecture. By way of example, in accordance with the asynchronous automated decisioning approach, the submission service 408 may instantiate a processing request 502 and forward data, such as an input data object 506, to a conversion service 412 for implementing a first stage of the asynchronous automated decisioning approach. The conversion service 412 may asynchronously (e.g., with respect to other components of the automated adjudication architecture) generate a set of structured data elements 510 from the input data object 506 and store the structured data element 510 within a polling queue 508 for retrieval by the polling service 410. At a defined interval, the polling service 410 may retrieve structured data elements 510 from the polling queue 508 and forward the structured data elements 510 to the decisioning service 414 and/or a user associated with the processing request. In addition, or alternatively, the decisioning service 414 may have access to the polling queue 508 and may receive the structured data elements 510 from the polling queue 508 at a polling frequency and/or based on a processing capacity of the decisioning component 414.

In either case, the decisioning service 414 may asynchronously (e.g., with respect to other components of the automated adjudication architecture) process the structured data element 510 to incrementally generate a request response 516 for the processing request 502. By doing so, the submission service 408, the conversion service 412, polling service 410, and decisioning service 414 may each individually and asynchronously process portions of a processing request 502 to generate a request response 516 that is tolerant to delays, processing constraints, and other interruptions specific to individual components of a decisioning system.

In some embodiments, the submission service 408 receives and provides a processing request 502 to the conversion service 412 to initiate an iteration of the asynchronous automated decisioning approach. For example, the conversion service 412 may receive, from the submission service 408, the processing request 502. The processing request 502 may comprise request metadata for an input data object 506. In response to receiving the processing request 502, the conversion service 412 may generate a request identifier 504 and provide the request identifier 504 to the submission service 408.

In some embodiments, the processing request 502 comprises a request submitted to an automated adjudication architecture through a submission service 408. The processing request 502, for example, may comprise a request to process an input data object 506 according to a particular set of rules. The particular set of rules may depend on the use case of the automated adjudication architecture. As one example, in a clinical use case, the processing request 502 may comprise a request to process a medical claim for reimbursement in accordance with reimbursement criteria set by a health plan for a member associated with medical claim. As another example, in a banking use case, the processing request 502 may comprise a request to deposit a check in accordance with deposit criteria for a bank.

A processing request 502 may comprise a message, data structure, object, and/or the like. By way of example, the processing request 502 may comprise an API request message, such as an HTTP request. The processing request 502 may comprise and/or reference (e.g., via one or more pointers, unique identifiers) request metadata for a particular processing task. In some examples, the processing request 502 may be serialized into a messaging protocol format, such as JSON, XML, and/or the like, for transmission between different components of the decisioning system. As described herein, the processing request 502 may initiate a workflow within the automated adjudication architecture by triggering a conversion service 412 to begin processing and associated input data object 506. In some examples, the processing request 502 may be received and forwarded to the conversion service 412 by the submission service 408. In some examples, the submission service 408 may handle a plurality of processing requests 502 concurrently by routing processing requests 502 to different instantiations of a conversion service 412.

In some embodiments, the request metadata comprises data associated with a processing request 502, such as a member identifier, a requested value, and/or the like. The request metadata, for example, may comprise contextual information associated with a processing request 502 that may be stored and leveraged to process information extracted from an input data object 506 associated with the processing request 502. The request metadata may depend on the use case of the automated adjudication architecture. As one example, in a clinical use case, the request metadata may comprise a member identifier, a requested reimbursement amount for a medical claim, a healthcare plan identifier, and/or the like. As another example, in a banking use case, the request metadata may comprise an account identifier, a bank identifier, and/or the like.

In some examples, request metadata may be received through an interface configured to generate a processing request 502 based on input to the interface. The request metadata, for example, may comprise responses to one or more prompts, fillable fields, and/or the like provided by an interface. In some examples, the request metadata may comprise one or more structured, contextual objects that may stored, transferred, and/or processed in a structured data format, such as a JSON object, a set of key-value pairs, and/or the like. In this manner, the request metadata may be store in a searchable manner to improve the speed and efficiency of downstream decisioning tasks. In some examples, the request metadata may be stored in a database in association with a request identifier and/or passed along with the processing request 502, and/or other requests, through different stages of an asynchronous automated decisioning approach.

In some embodiments, the submission service 408 receives the processing request 502, detects the request metadata, and preprocesses the request metadata before (and/or concurrently with) forwarding the processing request 502 to the conversion service 412. For example, the submission service 408 may validate and/or sanitize the request metadata to ensure data integrity and/or security. This may involve checking for required fields, validating data types, and/or encrypting sensitive information. The validated metadata may be indexed in a database in accordance with a request identifier 504 to allow for efficient querying and retrieval during the decisioning process.

In some embodiments, the conversion service 412 generates a request identifier 504 to track the processing request 502 as it is asynchronously processed by different components of the automated adjudication architecture. For example, the conversion service 412 may response to a processing request 502 with the request identifier 504 and, in response to the reception of the request identifier 504, the submission service 408 may store the request metadata in association with the request identifier 504. In addition, or alternatively, the submission service 408 may respond to a request identifier 504 by prompting a user (e.g., via an interface) for an input data object 506 for the processing request 502.

In some embodiments, the request identifier 504 is a unique identifier that is assigned to a processing request 502 for tracking purposes. The request identifier 504 enables multiple, asynchronous services to process the processing request 502, in parallel, while maintaining a coherent association between different components of the processing request 502 throughout the decision process. The request identifier 504 may comprise a string, one or more numeric values, and/or the like, that may be unique to the processing request 502. The request identifier 504, for example, may comprise a UUID (Universally Unique Identifier), sequential numbering index, combinations of timestamps, random values, and/or the like. As described herein, the request identifier 504 may be used as a unique identifier for storing data associated with a processing request 502. The request identifier 504, for example, may serves as a key for associating different pieces of data related to a single processing request 502. By way of example, the request identifier 504 may comprise a primary key in databases, a correlation identifier in a message queue, a lookup value in a cache, and/or the like. In this manner, different data generated by different services of the automated adjudication architecture may be correlated despite the asynchronous operations of the services within the automated adjudication architecture. By way of example, the request identifier 504 may stored in association with request metadata, an input data object 506, structured data elements 510 extracted from the input data object 506, a structured data object comprising a set of structured data elements 510, a conversion status of the structured data object, element decisions, request responses 516, and/or the like, to link each of these components across different services of the automated adjudication architecture.

In some embodiments, the conversion service 412 receives an input data object 506 that comprises a set of unstructured data elements and corresponds to the request identifier 504. For example, the conversion service 412 may receive the input data object 506 from the submission service 408. In some examples, the conversion service 412 may receive the input data object 506 in response to the request identifier 504. For instance, the submission service 408 may request an input data object 506 in response to the request identifier 504 and forward a received input data object 506 to the conversion service 412.

In some embodiments, the input data object 506 is an unstructured data structure that reflects information for a processing request 502. For example, the input data object 506 may comprise an image, a PDF, and/or any other representation of unstructured data for a processing request 502. In some examples, the input data object 506 may depend on a use case of the automated adjudication architecture. For example, in a clinical use case, an input data object 506 may comprise an image of a receipt, a PDF that records one or more line items of a medical service, and/or the like. In another example, in a banking use case, the input data object 506 may comprise an image of a check, money order, and/or the like. In any format, the input data object 506 may comprise a set of unstructured data elements that, may be processed and converted into one or more structured data elements that are recognizable to a decisioning service 414.

In some embodiments, the submission service 408 receives an input data object 506 for a request identifier 504 and stores the input data object 506 in association with the request identifier 504. The submission service 408 may forward the input data object 506 and/or a portion thereof to the conversion service 412. In addition, or alternatively, the submission service 408 may provide a status message to the conversion service 412 that comprises the request identifier 504 and indicates that the input data object 506 is ready (e.g., stored) for processing by the conversion service 412.

In some embodiments, the unstructured data elements of an input data object 506 comprise characteristics of an input data object 506, such as raw text, pixel characteristics, and/or the like, that convey a message that is interpretable to a user, but not recognized by computer. Unstructured data elements, for example, may be represented in their raw form within the computer system by binary image data, raw text strings, and/or other primitive data types that capture the content of the input data object 506. Such unstructured data elements may lack a formal structure and/or arrangement that would allow for the application of automated processing and decision-making operations. To prepare the data elements for downstream decisioning tasks, the conversion service 412 may convert the input data object 506 into a set of structured data elements 510 of a structured data object.

In some embodiments, the conversion service 412 converts the input data object 506 to a structured data object. For example, the conversion service 412 may convert the input data object 506 to a structured data object over one or more conversion operations. In some examples, the conversion service 412 may incrementally convert the input data object 506 to the structured data object by generating a set of structured data elements 510. Up to each of the set of structured data elements 510 may be at least temporarily stored in a polling queue 508 for further processing by one or more other services of the automated adjudication architecture. In this manner, a portion of a structured data object may be processed, asynchronously, by downstream services of the automated adjudication architecture while remaining portions of the structured data object are converted from the input data object 506. By way of example, the conversion service 412 may generate an empty structured data object for an input data object 506 and assign a pending conversion status to the structured data object. The conversion service 412 may generate structured data elements 510 for the structured data object until a set of structured data elements 510 is generated for the input data object. In some examples, the set of structured data element 510 may be generated for a structured data object until a stopping condition is reached.

In some embodiments, a structured data object is a structured representation of an input data object 506 that comprises a set of structured data elements 510 for an input data object 506 and corresponds to the request identifier 504. The structured data object, for example, may comprise a data structure that groups a set of structured data elements extracted from an input data object 506. In this manner, a structured data object may form a structured representation of an unstructured input data object 506. A structured data object, for example, may comprise a data structure and/or object within the computer system that is serialized into a standardized format, such as JSON, XML, and/or the like. This format allows for easy storage, transmission, and processing by various components of the automated adjudication architecture. The structured data object may be stored in a database, message queue, or in-memory data store for efficient retrieval and manipulation.

In some embodiments, a structured data element 510 is a unit within a structured data object that comprises a set of structured features from the input data object 506 that may be used as a basis for a decisioning service 414. A structured data element 510, for example, may comprise a standardized format for arranging a unit of individually processable information extracted from an unstructured input data object 506. The structured data element 510, for example, may be implemented as a data structure in computer memory, such as a JSON object, XML element, a database record, and/or the like. In some examples, the structured data element 510 may define a set of field-values pairs. The set of fields, for example, may be defined by a structuring ruleset for a particular use case. In a clinical use case, for example, the set of fields may comprise a time field, a service name field, a service description field, and/or a billed amount field that may form a line item of a medical services receipt. As another example, for a banking use case, the set of fields may comprise an amount, account number, routing number, name, bank, time, checking number, and/or the like that may form a line item for transferring currency between two banking accounts. In any case, the set of fields of a structured data element 510 may act as a schema and/or template for transforming raw input features extracted from an input data object 506 into a consistent, machine-readable format that is individually processable by downstream services of the automated adjudication architecture.

In some embodiments, the conversion service 412 generates a structured data element 510 from an input data object 506 by applying a structuring ruleset for a particular use case to a set of input features. For instance, the conversion service 412 may extract, using an OCR model, a set of input features from the input data object 506.

In some embodiment, the OCR model comprises one or more machine learning, natural language processing, and/or vision processing models configured, trained, and/or the like to extract input features from the unstructured data elements of an input data object 506. For instance, the OCR model may comprise a model designed to extract text and/or other relevant information from unstructured data elements to covert the unstructured data elements data into a set of machine readable input features. By way of example, an OCR model may comprise one or more image processing techniques and/or machine learning algorithms. In some examples, the OCR model may comprise one or more convolutional neural networks (CNNs) for feature extraction from images, recurrent neural networks (RNNs) or transformer architectures for sequence modeling in text recognition, and/or various computer vision algorithms for tasks such as image preprocessing, layout analysis, and/or character segmentation.

In some examples, the conversion service 412 may apply the OCR model to an input data objects 506 (e.g., scanned documents, PDFs, images) to generate a set of input features reflective of raw text, numeral, and/or the like that are depicted within the input data object 506. In some examples, the extracted input features may comprise extracted text and/or metadata associated with extracted text, such as a position (e.g., relative coordinates) of text elements within the input data object 506, font information, section and/or header identifiers, and/or the like. By way of example, an input feature may comprise raw text and/or other metadata for portions of the input data object 506. The set of input features extracted from the input data object 506 may represent the fundamental units of information extracted from the input data object 506, serving as the building blocks for further processing and analysis within the automated adjudication architecture. In some examples, up to each of the set of input features may comprise a set of feature properties, such as a text content, position coordinates, and other relevant metadata for generating one or more structured data elements 510 from the input data object 506. In this respect, the set of input features may comprise a rich set of information that goes beyond simple text extraction, enabling more sophisticated analysis and structuring of an input data object 506 into a set of structured data elements 510. For example, position coordinates associated with up to each of the input features may be used to detect relationships between different pieces of information, identify structural elements like headers or columns of the input data object 506, and/or the like.

In some embodiments, the conversion service 412 generates, using a structuring ruleset, the structured data element 510 based on the set of input features. For example, the conversion service 412 may assign one or more time classifications to a first subset of the set of features. In some embodiments, the time classification comprises a type classification that may be output by the OCR model and/or generated by a downstream time prediction model for an input feature. By way of example, an OCR model may output a set of input features and data type classification (e.g., date, text, numeric) for up to each of the set of input features. In some examples, a time classification may comprise a date type classification for an input feature that identifies the input feature as a date value. In addition, or alternatively, a time classification may comprise a classification from a time prediction model that identifies an input feature as a date value. By way of example, a time prediction model may comprise one or more natural language processing (NLP) techniques, regular expressions, and/or machine learning models trained for temporal data recognition. The time prediction model, for example, may be configured to identify and/or parse a set of input features to extract one or more date values based on an explicit formatting (e.g., “Jan. 15, 2023”) and/or implicit references (e.g., “next Tuesday”).

In addition, or alternatively, the conversion service 412 may generate, using a classification model, a subset of element predictions that respectively correspond to a remaining subset of the set of features. For instance, the conversion service 412 may generate, using the classification model, an element prediction for up to each of the remaining subset of the set of features. In some embodiments, the classification model may comprise a machine learning model that is trained to flag text of interest that is extracted from the input data object 506. The classification model, for example, may comprise a machine learning component designed to categorize and/or label input features based on a particular use case (and/or dictionary associated therewith). By way of example, a classification model may comprise a supervised machine learning algorithms, such as support vector machines (SVMs), random forests, neural networks, and/or the like. The classification model may be trained on domain-specific dataset of labeled text examples to learn patterns and/or features that distinguish different categories of text. In addition, or alternatively, the classification model may comprise a named entity recognition (NER) model configured to identify one or more key features from the set of input features based on one or more text comparison techniques, such as text vectorization (e.g., TF-IDF, word embeddings), entity chunking, entity extraction, and/or the like.

In some examples, the classification model may leverage a domain specific term dictionary to identify key features from the set of input features. The domain specific term dictionary, for example, may comprise a set of recognized entities for a domain, such as a set of current procedural terminology (CPT) codes for a clinical domain, a set of banking codes for a banking domain, and/or the like.

In some embodiments, an element prediction comprises an output from a classification model for an input feature of a set of input features. An element prediction, for example, may comprise a probabilistic and/or binary output that represents a likelihood that a unit of text is relevant for a particular use case. Element predictions, for example, may comprise measure of confidence and/or a binary indication of the similarity between an input feature and at least one of a set of defined terms within a domain. An element prediction, for example, may comprise a numerical value, confidence probability, Boolean flag, and/or the like for an input feature. In a probabilistic approach, these values might represent the probability (e.g., a float between 0 and 1) that a given input feature is relevant to the use case. In a binary approach, the predictions may comprise a binary flag indicating relevance. For probabilistic outputs, a classification model may comprise one or more activation functions (e.g., logistic regression, softmax-activated neural networks) configured to produce a binary prediction from probability distributions.

In some embodiments, an element prediction comprises a positive value (“1”) and/or a negative value (“0”) for an input feature. A positive value may indicate that the input feature is related to a particular use case. The negative value may indicate that the input feature is not related to a particular use case. In response to a positive value, the conversion component 412 may shortlist an input feature and as an element feature for use as a basis for a structured data element. In response to a negative value, the conversion component 412 may discard the input feature. In this manner, element predictions may act as a filter, allowing the conversion component 412 to generate a set of structured data elements for up to each of a set of element features predicted to be relevant to a particular use case. By way of example, the conversion component 412 may assign an element label to up to each of second subset of input features that are assigned a positive element prediction.

In some embodiments, the conversion component 412 may assign one or more value classifications to a third subset of the set of features. In some embodiments, the value classification comprises another type classification that may be output by the OCR model and/or generated by a downstream value prediction model for an input feature. By way of example, an OCR model may output a set of input features and data type classification (e.g., date, text, numeric) for up to each of the set of input features. In some examples, a value classification may comprise a numeric type classification for an input feature that identifies the input feature as a numerical value. In addition, or alternatively, a value classification may comprise a classification from a value prediction model that identifies an input feature as a numeric value. By way of example, a value prediction model may comprise one or more natural language processing (NLP) techniques, regular expressions, and/or machine learning models trained for value data recognition. The value prediction model, for example, may be configured to identify and/or parse a set of input features to extract one or more numeric values based on an explicit formatting (e.g., “$450.00”) and/or implicit references (e.g., “two dollars”).

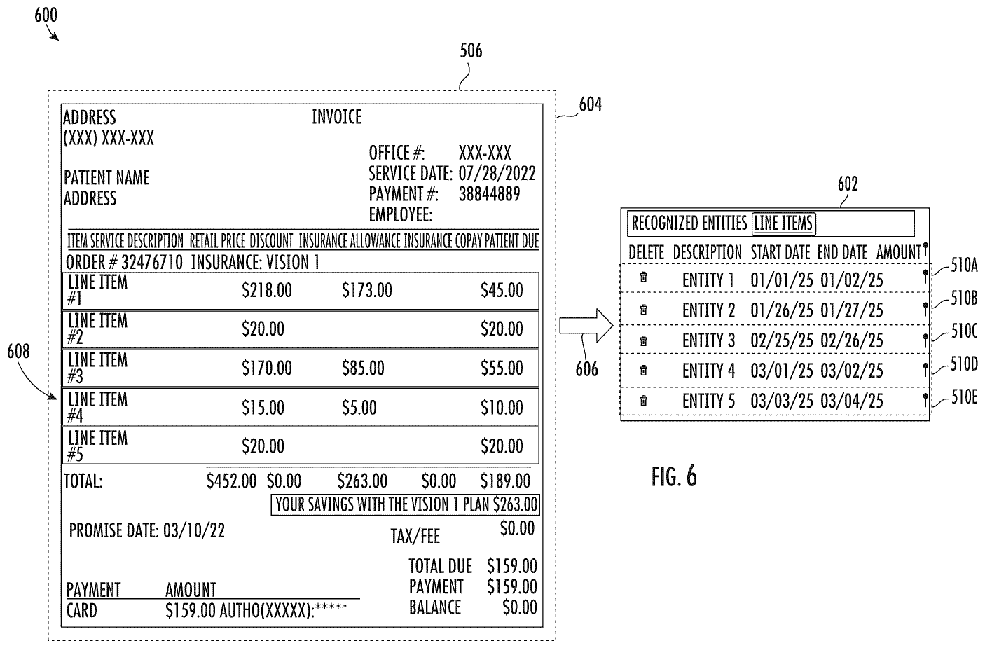

In this manner, the conversion component 412 may extract a set of input features from an input data object 506 and classify up to each of the set of input features into one or more different classification categories (e.g., time, element, value). In some examples, the conversion component 412 may combine one or more input features from one or more of the different classification categories to generate a structured data element 510 for the input data object 506. The conversion component 412, for example, may arrange the one or more input features in accordance with a structuring ruleset, as described in further detail with respect to FIG. 6.

In some embodiments, the conversion component 412 generates the structured data element 510 based on an element feature from the remaining subset of the set of features that corresponds to the one of the subset of element predictions, a time feature from the first subset of the set of features, and/or one or more contextual features. By way of example, as described in further detail with reference to FIG. 6, a structured data element 510 may comprise one or more element features that are positionally associated with each other within the input data object 506.

In some embodiments, the conversion component 412 stores the structured data element 510 within the polling queue 508 and in association with the request identifier 504. For example, the conversion component 412 may generate a set of structured data elements 510 for an input data object 506 and add up to each of the set of structured data elements 510 to the polling queue 508 as they are generated. Up to each of the structured data elements 510 may be stored with a request identifier 504 to group the structured data elements 510 within a structured data object for generating a request response 516 to the processing request 502. In some examples, the conversion component 412 may assign an approved conversion status to the structured data object in the event the set of structured data elements 510 is completed. The conversion status may be stored within the polling queue 508 in association with the structured data object and/or one or more structured data elements 510 of the structured data object.

In some embodiments, the polling queue 508 comprises an intermediate storage structure for temporarily storing structured data elements 510 of a structured data object between polling requests 512 from a polling component 410. The polling queue 508 may serves as a buffer between the conversion component 412 and the polling component 410, enabling efficient asynchronous processing of data. The polling queue 508, for example, may comprise data structure in computer memory and/or persistent storage that may leverage one or more queue implementations, such as a first-in-first-out (FIFO) queue, a priority queue, a distributed queue system, and/or the like to arrange a set of data structures. In this manner, the polling queue 508 may manage a storage and retrieval of structured data elements 510.

In some embodiments, a structured data element 510 is stored within the polling queue 508 in association with request identifier 504 to maintain data integrity and/or traceability. In some examples, the conversion component 412 may add newly processed structured data elements 510 to the polling queue 508 in accordance with a queuing protocol (e.g., first in first out, first in last out) of the polling queue 508. In this manner, at regular polling intervals, the polling component 410 may access the polling queue 508 to retrieve a set of queued structured data elements 510. This decoupled approach allows the conversion component 412 to process input data objects continuously without being constrained by the polling frequency of the polling component 410.

In some embodiments, the conversion component 412 stores structured data elements 510 and/or status information for an associated structured data object within the polling queue 508. For instance, up to each structured data element 510 may be stored with a conversion status for the structured data object. In addition, or alternatively, a conversion status may stored in association with a request identifier 504 for the structured data object.

In some embodiments, a conversion status is a data element that identifies a status of a conversion process for an input data object 506. A conversion status provides information about the progress and state of the transformation of an unstructured input data object into a structured format suitable for automated processing and decisioning. In some examples, a conversion status may be implemented as an enumerated type and/or a set of predefined numeric, binary, and/or string values that represent different stages and/or outcomes of the conversion process. By way of example, a conversion status may comprise an “initiated”, “in progress”, “partially complete”, “complete”, and/or like. In addition, or alternatively, a conversion status may comprise one or more exception states, such as “failed”, “error”, and/or the like.

In some embodiments, the conversion component 412 is configured to generate a structured data element 510 for up to each of a subset of element features identified within a set of input features extracted from an input data object 506. In some examples, the conversion component 412 may store in association with a request identifier 504 and/or assign to a structured data element 510 an “in progress” conversion status for up to each structured data element 510 that is generated using an element feature of the subset of element features until a last element feature of the subset of element features is reached. In response to generating a structured data element 510 for a last element feature of the subset of element features, the conversion component 412 may store in association with a request identifier 504 and/or assign to a structured data element 510 a “complete” conversion status that signals a structured data object is completely converted for an input data object 506.

In some embodiments, the conversion component 412 receives, from the polling component 410, the polling request 512. Responsive to receiving the polling request 512, the conversion component 412 may provide, to the polling component 410, a polling response 514 that comprises one or more request identifiers 504, structured data elements 510, conversion statuses for the structured data objects, and/or the like. In addition, or alternatively, the polling component 410 may directly access the polling queue 508 to retrieve a polling response 514 from the conversion component 412.

In some embodiments, the polling request 512 comprises a request message that is initiated by the polling component 410 to the conversion component 412 at a polling interval. A polling request 512, for example, may comprise a mechanism for asynchronous communication between different components of the automated adjudication architecture, specifically designed to check for, retrieve, and distribute newly processed data between the different components of the automated adjudication architecture. In some examples, a polling request may comprise an HTTP request, such as an HTTP GET, HTTP POST, and/or the like. In addition, or alternatively, a polling request 512 may comprise a remote procedure call (RPC), RESTful API, GraphQL, gRPC, and/or the like depending on a communication protocol of the automated adjudication architecture.

In some embodiments, a polling request 512 comprises one or more instructions for retrieving data elements within a polling queue 508 from a conversion component 412. For instance, the polling request 512 may comprise one or more instructions that cause the conversion component 412 to check its polling queue 508 and, in response to a non-empty polling queue 508, provide a polling response 514 to the polling component 410 that comprises the contents of the polling queue 508. In some examples, the conversion component 412 may empty the polling queue 508 in response to the polling response 514.

The use of polling requests 512 enables loose coupling between the conversion component 412 and the decisioning component 414, allowing them to operate asynchronously. This design improves the overall system's resilience and scalability, as the conversion component 412 may continue processing input data objects 506 without being constrained by the speed of the decisioning component 414. In some examples, the polling interval may be adjusted to balance between responsiveness and system load, providing flexibility in managing resource utilization and processing latency.

In some embodiments, a polling response 514 comprises a response message to a polling request 512 that comprises the contents of a polling queue 508. For instance, a polling response 514 may comprise a set of structured data elements 510 that are queued as ready for processing. In addition, or alternatively, a polling response 514 may comprise one or more conversion statuses, request metadata, and/or the like. By way of example, the polling response 514 may comprise a data package returned by the conversion component 412 in reply to a polling request 512, containing newly processed information that is ready for further processing or decisioning by the decisioning component 414. In some examples, the polling response 514 may comprise a structured data format, such as JSON and/or XML, that may encapsulate the contents of the polling queue 508. The polling response 514 may be transmitted as the body of an HTTP response, as a return value from an RPC call, through a message queue system, and/or the like depending on the communication protocols of the automated adjudication architecture.

In some embodiments, the decisioning component 414 generates, using a decisioning ruleset, a request response 516 based on the structured data element 510 and/or request metadata, such as a member identifier, request value, and/or the like. The decisioning component 414, for example, may receive, from the polling component 410, the request identifier 504 and/or one or more structured data elements 510 of a structured data object. The decisioning component 414 may generate, using the decisioning ruleset of the decisioning component 414, a request response 516 based on the one or more structured data elements 510. For example, the decisioning component 414 may generate an element decision for up to each structured data element 510 of the structured data object for the request identifier 504. The decisioning component 414 may generate the request response 516 based on a set of element decisions for the structured data object and/or the request metadata for the processing request 502.

In some embodiments, a decisioning ruleset is machine learning and/or rule-based model that applies a set of rules and/or criteria to structured data object and/or structured data elements thereof. A decisioning ruleset, for example, may be comprise a logical data structure, such as a logic tree, and/or the like, that may be applied to individual structured data elements to determine an element decision (e.g., approval, rejection) for up to each of a set of structure structured data elements 510. By way of example, a decisioning ruleset may comprise a series of conditional statements arranged as nodes within a tree data structure. In addition, or alternatively, the decisioning ruleset may comprise a machine learning binary classification model, such as a neural network, random forest, and/or the like that may be trained to generate an element decision for a structured data element 510.

In some examples, a decisioning ruleset may be determined for a structured data element 510 based on request metadata associated with a processing request 502. For instance, a decisioning ruleset may be specific to a particular member identifier, banking institution, healthcare plan, and/or the like depending on the use case. In addition, or alternatively, a decisioning ruleset may generate an element decision for a structured data element 510 based on the request metadata. By way of example, the decisioning ruleset may be configured to generate an element decision for a structured data element 510 based on a comparison between the structured data element 510 and the request metadata for a processing request 502. By way of example, in a claim processing use case, this may involve evaluating various attributes of the structured data element against the rules, such as component dates, amounts, and/or eligible item codes.

A decisioning ruleset, for example, may provide a systematic way to codify complex rules and criteria into a format that may be automatically applied to structured data. In this way, a decisioning ruleset may enable consistent, automated decision-making on individual structured data elements 510 based on predefined criteria. This allows for rapid processing of large volumes of structured data in a consistent manner. The ruleset approach also provides flexibility, as rules may be updated over time to reflect changes without requiring modifications to the core decisioning engine code.

In some embodiments, an element decision comprises an element-level output for an individual structured data element extracted from an input data object 506. An element decision, for example, may comprise an output from a decisioning ruleset with respect to a particular structured data element 510. In some examples, an element decision may comprise an authorization and/or denial of a structured data element 510 in view of the decisioning ruleset. By way of example, in a clinical example, an element decision may comprise a authorization and/or denial of a particular line item from a medical claim. As another example, in a banking use case, an element decision may comprise an authorization and/or denial of a deposit to a bank account. In some examples, an element decision may be implemented as a data structure comprising one or more fields, such as authorization status (e.g. authorized, denied, partially authorized), authorized amount, reason codes, and any other relevant metadata. This structure may be populated by the decisioning component 414 based on an application of the decisioning ruleset to the structured data element 510.

In some examples, an element decision may be stored in a database or in-memory data structure, associated with the request identifier 504 and/or a unique identifier for a structured data element 510. In some examples, an element decision may comprise an atomic unit of a request response 516 for a processing request 502. The decisioning component 414, for example, may leverage a series of element decisions to break down an overall request into manageable, atomic units that may be evaluated independently. This approach allows for parallel processing of elements and provides granular insight into which specific parts of a processing request 502 are authorized, denied, and/or the like. In some examples, the decisioning component 414 may aggregate an element decision for up to each of a set of structured data elements of a structured data object to generate a request response 516 for a processing request 502.

In some embodiments, the request response 516 comprises an aggregated response generated for a processing request 502. A request response 516, for example, may comprise a final outcome of processing up to each of set of individual structured data elements associated with a particular request identifier 504. In some examples, a request response 516 comprise a data element that describes the overall authorization status, approved amount, and/or any other relevant messages and/or codes for responding to a processing request 502. In some examples, the decisioning component 414 may populate a request response 516 by aggregating the element decisions for up to each of a set of structured data elements 510 of a structured data object corresponding to a request identifier 504 of the processing request. The aggregation logic, for example, may comprise summing approved amounts, determining an overall status based on individual element statuses, collecting any pertinent messages, and/or the like.

In some embodiments, the decisioning component 414 provides the request response 516 to the polling component 410 (e.g., directly or through the conversion component 412), which may forward the request response 516 to a sender of a processing request 502. In some examples, the decisioning component 414 may provide the request response to the conversion component 412. In such a case, the request response 412 may be stored within the polling queue 508 and provided to the polling component 410 in response a polling request 512. By way of example, the polling queue may comprise a processing status (e.g., in addition to or alternative to the conversion status) associated with a structured data object indicating whether a request response has been received from the decisioning component 414. Upon determining that the last structured data element has received a response, the decisioning component 414 and/or conversion component 412 may modify the processing status and, in response to the modified processing status generate a response data structure to approve, deny and/or authorize the processing request.

In addition, or alternatively, the request response 412 may be provided from the decisioning component 414 to the polling component 410 in response to a status request (not shown) with the request identifier. For example, the decisioning component 414 may store the request response 516 (and/or portions thereof) with a processing status, receive a status request from the polling component 410, and, in response to the status request and a determination that the processing status is complete, provide the request response 516 to the polling component 410. In some examples, the computing system 10 may control a computing device based on the request response to approve, deny, or authorize the input data object corresponding to the processing request in accordance with the response data structure.

In either of the above variations, by asynchronously generating and aggregating portions of the request response 516 as a conversion component 412 incrementally converts an input data object 506 to a structured data object, the decisioning component 414 may provide a request response 516 in near-real time.

FIG. 6 depicts an operational example 600 of a data conversion approach in accordance with some embodiments of the present disclosure. As depicted, the operational example 600 comprises a clinical example in which an asynchronous automated decisioning approach may be leverage to automatically adjudicate a medical claim based on an input data object 506 (e.g., an image of a medical services receipt). As shown, during a data conversion approach of the asynchronous automated decisioning approach, a conversion component may apply a structuring ruleset 606 to the input data object 506 to extract a set of structured data elements 510A-E to form a structured data object, a graphical representation of which is depicted at 602. For example, the structured data object may comprise a JSON file, XML file, and/or the like Up to each of the set of first structured data element 510A-E, for example, may correspond to line items represented by unstructured data elements of the input data object 506. The structured data elements 510A-E, for example, may comprise a first structured data element 510A, a second structured data element 510B, a third structured data element 510C, a fourth structured data element 510D, and/or a fifth structured data element 510E that respectively correspond to different line items positioned within a content portion 608 of the input data object 506.

As shown in the operational example 600, in some examples, a structured data element 510 may comprise a combination of input features that are positioned within different, non-adjacent portions of an input data object 506. By way of example, each of the structured data elements 510A-E of the operational example 600 comprise a description feature and an amount feature that are positioned within a content portion 608 of the input data object 506 and a start and end time positioned within a header 604 of the input data object 506. In some examples, the conversion component may leverage the structuring ruleset 606 to locate and associate one or more combinations of input features extracted from the input data object 506 to generate structured data objects 602 that combine the features in a manner that is processable by downstream decisioning components.

In some examples, the structuring ruleset 606 may define one or more combinations of input features for a structured data element 510. The combination of input features, for example, may define a set sequence of feature classification types. By way of example, a structuring ruleset may define a combination of input features that comprises an element feature (e.g., a description), a time feature (e.g., a start and end date), and/or a value feature (e.g., a billed amount) for a structured data element 510. In addition, or alternatively, the structuring ruleset 606 may define one or more positional rules for associating a combination of input features. By way of example, the structuring ruleset 606 may define a positional structuring rules for associating input features within a horizontal and/or vertical plane. In some examples, the structuring ruleset 606 may define one or more sections for extracting supplemental features, such a time features in the instant example, to supplement one or more associated features to complete a combination of input features for a structured data element 510. By way of example, the structuring ruleset 606 may indicate a header 604 portion for assigning a time feature to one or more associated features in the event that a time feature is not positioned within a horizontal and/or vertical plane of the one or more associated features.

In some embodiments, the structuring ruleset 606 comprises criteria for constructing a structured data element 510. The structuring ruleset 606 defines a process and rules by which input features extracted from unstructured input data objects 506 may be transformed into a standardized, structured format, such as the structured data object 602, that may be processed by downstream decisioning components. In this manner, a structuring ruleset 606 may serve as a blueprint for converting raw input features into meaningful, organized data elements. A structuring ruleset 606 may be implemented as a set of algorithms and/or data transformation rules encoded in software. By way of example, the structuring ruleset 606 may comprise regular expressions for pattern matching, decision trees for classification, and/or more complex machine learning models for advanced feature extraction and categorization.

In some embodiments, the conversion component 412 determines a structured data element 510 based on one of the subset of element predictions for the set of input features. For instance, the conversion component 412 may determine a structured data element 510 for up to each of a subset of element features from a set of input features that are respectively associated with positive element predictions. In some examples, the conversion component 412 may generate a structured data element 510 for each element feature of the subset element features with an element prediction that meets or exceeds a positive threshold. The positive threshold, for example, may comprise a binary (e.g., 1) and/or probabilistic value (e.g., 0.6, 0.8, 0.95). The positive threshold, for example, may be configured to determine each term of interest represented by the input data object 506.

In some embodiments, the conversion component 412 determines a combination input features that are associated with an element feature to generate a structured data element 510. The combination of input features may be determined by applying the structuring ruleset 606 to the positional attributes and/or the type classifications respectively associated with the set of input features. By way of example, an element feature may comprise a first unit of text and a first relative coordinate pair. A time feature may comprise a second unit of text and a second relative coordinate pair. In some examples, the conversion component 412 may determine the time feature for a structured data element 510 based on the second relative coordinate pair (e.g., indicating that the time feature is positioned in a header 604 associated with a content portion 608 in which the element feature is positioned). By way of example, the second relative coordinate pair may be associated with a header 604 of the input data object 506 and/or a content portion 608 of the input data object 506 that corresponds to the element feature.

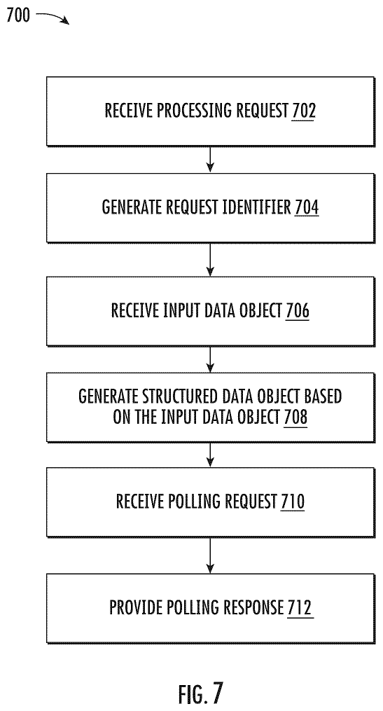

FIG. 7 depicts a flowchart diagram of an asynchronous conversion process 700 in accordance with some embodiments of the present disclosure. The flowchart diagram depicts one or more operations performed by an asynchronous component to incrementally convert an unstructured input data object into a structure form for downstream decisioning tasks. The process 700 may be implemented by one or more computing devices, entities, and/or systems described herein. For example, via the various steps/operations of the process 700, the computing system 101, and/or a conversion component thereof, may incrementally convert an input data object to a structured data object comprising a set of structure data elements. By isolating the conversion task from traditionally connected downstream operations, the process 700 improves the speed, efficiency, reliability, and configurability of a data conversion task.

FIG. 7 illustrates an example process 700 for explanatory purposes. Although the example process 700 depicts a particular sequence of steps/operations, the sequence may be altered without departing from the scope of the present disclosure. For example, some of the steps/operations depicted may be performed in parallel or in a different sequence that does not materially impact the function of the process 700. In other examples, different components of an example device or system that implements the process 700 may perform functions at substantially the same time or in a specific sequence.

In some embodiments, the process 700 comprises, at operation 702, receiving a processing request. For example, the computing system 101 (and/or a conversion component thereof) may receive from the submission component, a processing request that comprises request metadata for an input data object. In some examples, the request metadata may comprise a member identifier.

In some embodiments, the process 700 comprises, at operation 704, generating a request identifier. For example, the computing system 101 (and/or a conversion component thereof) may, in response to receiving the processing request, generate the request identifier and provide the request identifier to the submission component.

In some embodiments, the process 700 comprises, at operation 706, receiving an input data object. For example, the computing system 101 (and/or a conversion component thereof) may receive, from a submission component, an input data object that (i) comprising a set of unstructured data elements and (ii) corresponds to a request identifier. For instance, the input data object may be received in response to the request identifier.

In some embodiments, the process 700 comprises, at operation 708, converting the input data object to a structured data object. For example, the computing system 101 (and/or a conversion component thereof) may convert the input data object to the structured data object by (i) extracting, using an OCR model, a set of input features from the input data object, (ii) generating, using a structuring ruleset, a structured data element based on the set of input features, and (iii) storing the structured data element within a polling queue and in association with the request identifier.

For example, the computing system 101 (and/or conversion component thereof) may assign a time classification to a first subset of the set of input features. The computing system 101 (and/or conversion component thereof) may generate, using a classification model, up to a subset of element predictions that respectively correspond to the remaining subset of the set of input features. The computing system 101 (and/or conversion component thereof) may determine the structured data element based on one of the subset of element predictions. For instance, the computing system 101 (and/or the conversion component thereof) may generate the structured data element 510 based on (i) an element feature from the remaining subset of the set of features that corresponds to the one of the subset of element predictions and (ii) a time feature from the first subset of the set of features.

In some examples, the element feature may comprise a first unit of text and/or a first relative coordinate pair, the time feature comprises a second unit of text and a second relative coordinate pair, and/or the time feature may be determined for the structured data element based on the second relative coordinate pair. For instance, the second relative coordinate pair may be associated with a header portion of the input data object and/or a content portion of the input data object that corresponds to the element feature.

In some embodiments, the process 700 comprises, at operation 710, receiving a polling request. For example, the computing system 101 (and/or a conversion component thereof) may receive, from a polling component, the polling request.

In some embodiments, the process 700 comprises, at operation 712, providing a polling response. For example, the computing system 101 (and/or a conversion component thereof) may, responsive to receiving the polling request, provide, to the polling component, a polling response that comprises at least one of the request identifier, the structured data element, and/or a conversion status for the structured data object.

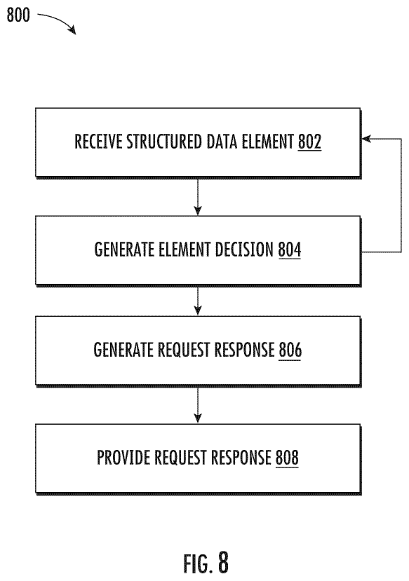

FIG. 8 depicts a flowchart diagram of an asynchronous decisioning process 800 in accordance with some embodiments of the present disclosure. The flowchart diagram depicts one or more operations performed by an asynchronous component to incrementally generate decisions for a structured data object. The process 800 may be implemented by one or more computing devices, entities, and/or systems described herein. For example, via the various steps/operations of the process 800, the computing system 10, and/or a decisioning component thereof, may apply a decisioning ruleset to individual components of a structure data object as the structured data object is incrementally converted from unstructured data. By isolating the decision task from traditionally connected upstream operations, the process 800 improves the speed, efficiency, reliability, and configurability of a decisioning task.

FIG. 8 illustrates an example process 800 for explanatory purposes. Although the example process 800 depicts a particular sequence of steps/operations, the sequence may be altered without departing from the scope of the present disclosure. For example, some of the steps/operations depicted may be performed in parallel or in a different sequence that does not materially impact the function of the process 800. In other examples, different components of an example device or system that implements the process 800 may perform functions at substantially the same time or in a specific sequence.

In some embodiments, the process 800 comprises, at operation 802, receiving a request identifier and structured data element. For example, the computing system 101 (and/or decisioning component thereof) may receive the request identifier and the structured data element. In some examples, an input data object may be incrementally converted to the structured data object by a conversion component and provided to the decisioning component in one or more increments of structured data elements. The computing system 101 (and/or decisioning component thereof) may receive, by the decisioning component and from a polling component, the request identifier and/or the structured data element.

In some embodiments, the process 800 comprises, at operation 804, generating an element decision for the structured data element. For example, the computing system 101 (and/or decisioning component thereof) may generate, using a decisioning ruleset of the decisioning component, a request response based on the structured data element. In some examples, the computing system 101 (and/or decisioning component thereof) may return to operation 804 to wait for and/or process another structured data element for the structured data object until a stopping condition is detected. The stopping condition, for example, may comprise a reception of a conversion status indicating that the structured data object is complete.

In some embodiments, the process 800 comprises, at operation 806, generating a request response for a processing request. For example, the computing system 101 (and/or decisioning component thereof) may generate, using the decisioning ruleset, the request response based on up to each structured data element of a structured data object and request metadata, such as a member identifier.

In some embodiments, the process 800 comprises, at operation 808, providing the request response. For example, the computing system 101 (and/or decisioning component thereof) may provide the request response to the polling component.

In some embodiments, the process 800 comprises a second, decisioning process that may be asynchronously performed with a first, conversion process as described with reference to FIG. 7. In some examples, the conversion process may be executed by a conversion component of the computing system 101 and/or the decisioning process may be executed by a decisioning component of the computing system 101. For example, the conversion component and the decisioning component may be executed asynchronously. The conversion component, for example, may be implemented within a first software container and/or the decisioning component may be implemented within a second software container that is different than the first software container.

In some embodiments, the decisioning ruleset may be encapsulated in the second software container in which the decisioning component may be executed. In some examples, the computing system 101 may receive an update to the decisioning ruleset, and responsive to the update to the decisioning ruleset, the computing system 101 may (i) disable the second software container without impacting the first software container, (ii) modify the second software container, and then (iii) enable the second software container. In some examples, the computing system 101 may disable the second software container without impacting the first software container by delaying a polling request from the polling component.

Some techniques of the present disclosure enable the generation of action outputs that may be performed to initiate one or more real world actions to achieve real-world effects. The techniques of the present disclosure may be used, applied, and/or otherwise leveraged to generate request responses for a variety of unstructured data objects. In some examples, the request responses of the present disclosure may trigger action outputs (e.g., through control instructions) to automate computerized and/pr physical actions, such as a denial and/or approval of a medical claim, a mailing a notice reflective of a decision, initiating a reimbursement and/or deposit action, and/or the like. The action outputs may control various aspects of a client device, such as the display, transmission, and/or the like of data reflective of an alert, and/or the like. The alert may be automatically communicated to a user and/or may be used to initiate a security protocol (e.g., locking a computer), a robotic action (e.g., performing an automated screening process), and/or the like.

In some examples, the computing tasks may comprise actions that may be based on a particular domain. A domain may comprise any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may comprise the initiation of automated instructions across and between devices, automated notifications, automated scheduling operations, automated precautionary actions, automated security actions, automated data processing actions, and/or the like.

### IV. CONCLUSION

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as comprising logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations can be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “including,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and can be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” can be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters (e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may comprise any type of model configured, trained, and/or the like to generate a prediction output for a model input. In some examples, any of the logic, component(s), routines, and/or the like discussed herein may be implemented as a machine-learned model.

The machine-learned model may comprise one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112 (f) unless traditional means-plus-function language is expressly recited, such as “means for” or “step for” language being explicitly recited in the claim(s).

### V. EXAMPLES

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described here in. For example, a computing system may comprise a single computing entity that is configured to perform the steps/operations of a particular example. In addition, or alternatively, a computing system may comprise multiple dedicated computing entities that are respectively configured to perform one or more of the steps/operations of a particular example. By way of example, the multiple dedicated computing entities may coordinate to perform the steps/operations of a particular example.

What is claimed is:

1. A computer-implemented method comprising:
receiving, by one or more processors, a first request comprising request metadata and an input data object that corresponds to a request identifier, wherein the input data object comprises unstructured data;
generating, by the one or more processors and based on the input data object, a structured data object comprising a set of structured data elements by:
(i) extracting, using an optical character recognition model, a set of input features from the input data object,
(ii) generating, using a structuring ruleset and based on the set of input feature, a first structured data element of the structured data objects, and
(iii) storing the first structured data element in association with the request identifier within a polling queue;
determining, by the one or more processors and using a decisioning ruleset and based on the structured data object and the request metadata, a request response;
receiving, by the one or more processors and from a polling component, a second request requesting a status of processing the input data object; and
responsive to receiving the request and based at least in part on determining that generation of the set of structured data elements is complete, providing, by the one or more processors and to the polling component, the structured data object and the request response.

2. The computer-implemented method of claim 1, wherein the structured data object is generated by a conversion component, the request response is asynchronously determined by a decisioning component, the second request comprises a polling request from the polling component, and providing, to the polling component, the structured data object and the request response comprises:
providing, by the decisioning component, the request response to the conversion component; and
providing, by the conversion component, the request response to the polling component in response to the polling request.

3. The computer-implemented method of claim 1, wherein the structured data object is generated by a conversion component, the request response is asynchronously determined by a decisioning component, the second request comprises a status request from the polling component, and providing, to the polling component, the structured data object and the request response comprises:
storing, by the decisioning component, the request response; and
providing, by the decisioning component, the request response to the polling component in response to the status request.

4. The computer-implemented method of claim 3, wherein the conversion component is implemented within a first software container and the decisioning component is implemented within a second software container that is different than the first software container.

5. The computer-implemented method of claim 4, further comprising:
receiving an update to the decisioning ruleset; and
responsive to the update to the decisioning ruleset, (i) disabling the second software container, (ii) modifying the second software container as a modified software container, and (iii) instantiating the modified software container.

6. The computer-implemented method of claim 5, wherein disabling the second software container comprises delaying the polling request from the polling component.

7. The computer-implemented method of claim 1, wherein generating, using the structuring ruleset, the structured data element based on the set of input features comprises:
determining a time classification based on a first subset of the set of input features;
associating the time classification with the first subset;
generating, using a classification model, a subset of element predictions that respectively describe a relevance of a second subset of the set of input features to a particular use case; and
generating the structured data element based on (i) an element feature from the second subset of the set of input features based on the subset of element predictions and (ii) a time feature from the first subset of the set of input features.

8. The computer-implemented method of claim 7, wherein the element feature comprises a first unit of text and a first relative coordinate pair, the time feature comprises a second unit of text and a second relative coordinate pair, and the time feature is determined for the structured data element based on the second relative coordinate pair.

9. The computer-implemented method of claim 8, wherein the second relative coordinate pair is associated with a header portion of the input data object or a content portion of the input data object that corresponds to the element feature.

10. The computer-implemented method of claim 1, wherein the polling queue comprises a processing status associated with one or more of the set of structured elements and indicating whether an element response has been received and computer-implemented method further comprises, upon determining that a last structured data element of the set of structured data elements has received an element response, determining the request response.

11. The computer-implemented method of claim 1, further comprising controlling a computing device based on the request response to approve, deny, or authorize the input data object corresponding to the processing request.

12. A system comprising:
one or more processors; and
one or more memories storing processor-executable instructions that, when executed by the one or more processors, cause the one or more processors to perform operations comprising:
receiving a first request comprising request metadata and an input data object that corresponds to a request identifier, wherein the input data object comprises unstructured data;
generating, based on the input data object, a structured data object comprising a set of structured data elements by:
(i) extracting, using an optical character recognition model, a set of input features from the input data object,
(ii) generating, using a structuring ruleset and based on the set of input feature, a first structured data element of the structured data object s, and
(iii) storing the first structured data element in association with the request identifier within a polling queue;
determining, using a decisioning ruleset and based on the structured data object and the request metadata, a request response;
receiving, from a polling component, a second request requesting a status of processing the input data object; and
responsive to receiving the request and based at least in part on determining that generation of the set of structured data elements is complete, providing, to the polling component, the structured data object and the request response.

13. The system of claim 12, wherein the structured data object is generated by a conversion component, the request response is asynchronously determined by a decisioning component, the second request comprises a polling request from the polling component, and providing, to the polling component, the structured data object and the request response comprises:
providing, by the decisioning component, the request response to the conversion component; and
providing, by the conversion component, the request response to the polling component in response to the polling request.

14. The system of claim 12, wherein the structured data object is generated by a conversion component, the request response is asynchronously determined by a decisioning component, the second request comprises a status request from the polling component, and providing, to the polling component, the structured data object and the request response comprises:
storing, by the decisioning component, the request response; and
providing, by the decisioning component, the request response to the polling component in response to the status request.

15. The system of claim 14, wherein the conversion component is implemented within a first software container and the decisioning component is implemented within a second software container that is different than the first software container.

16. The system of claim 14, wherein the operations further comprise:
receiving an update to the decisioning ruleset; and
responsive to the update to the decisioning ruleset, (i) disabling the second software container, (ii) modifying the second software container as a modified software container, and (iii) instantiating the modified software container.

17. The system of claim 16, wherein the operations further comprise, wherein disabling the second software container comprises delaying the polling request from the polling component.

18. The system of claim 12, wherein generating, using the structuring ruleset, the structured data element based on the set of input features comprises:
determining a time classification based on a first subset of the set of input features;
associating the time classification with the first subset;
generating, using a classification model, a subset of element predictions that respectively correspond to a remaining subset of the set of input features;
determining the structured data element based on one of the subset of element predictions; and
generating the structured data element based on (i) an element feature from the remaining subset of the set of input features that corresponds to the one of the subset of element predictions and (ii) a time feature from the first subset of the set of input features.

19. One or more non-transitory computer-readable media storing processor-executable instructions that, when executed by one or more processors, cause the one or more processors to perform operations comprising:
receiving a first request comprising request metadata and an input data object that corresponds to a request identifier, wherein the input data object comprises unstructured data;
generating, based on the input data object, a structured data object comprising a set of structured data elements by:
(i) extracting, using an optical character recognition model, a set of input features from the input data object,
(ii) generating, using a structuring ruleset and based on the set of input feature, a first structured data element of the structured data objects, and
(iii) storing the first structured data element in association with the request identifier within a polling queue;
determining, using a decisioning ruleset and based on the structured data object and the request metadata, a request response;
receiving, from a polling component, a second request requesting a status of processing the input data object; and
responsive to receiving the request and based at least in part on determining that generation of the set of structured data elements is complete, providing, to the polling component, the structured data object and the request response.

20. The one or more non-transitory computer-readable media of claim 19, wherein generating, using the structuring ruleset, the structured data element based on the set of input features comprises:
determining a time classification based on a first subset of the set of input features;
associating the time classification with the first subset;
generating, using a classification model, a subset of element predictions that respectively correspond to a remaining subset of the set of input features;
determining the structured data element based on one of the subset of element predictions; and
generating the structured data element based on (i) an element feature from the remaining subset of the set of input features that corresponds to the one of the subset of element predictions and (ii) a time feature from the first subset of the set of input features.
